(19) United States
(12) Patent Application Publication
(10) Pub. No.: US 2012/0220450 A1
(43) Pub. Date: Aug. 30, 2012

(54) METHOD OF COATING CATALYST ON A SUBSTRATE

(76) Inventors: William Peter Addiego, Big Flats, NY (US); Michael John Bennett, Corning, NY (US)

(21) Appl. No.: 13/399,570

(22) Filed: Feb. 17, 2012

Related U.S. Application Data
(60) Provisional application No. 61/447,257, filed on Feb. 28, 2011.

(51) Int. Cl. B01J 37/04

(52) U.S. Cl. 502/62; 502/159

(57) ABSTRACT

A method of coating a substrate with a catalytically active material using a polymer latex is disclosed. A slurry of catalytically active material and water is prepared, the catalytically active material containing activated carbon, and a binder is prepared that contains a polymer latex having a glass transition temperature of 10 C to 30 C. The slurry is combined with the binder to form a mixture, which can then be applied to the substrate to achieve a mixture loading of 20 to 30 weight percent on the substrate. The latex polymer binders can bind a catalytically active platinum on activated carbon powder to a cordierite honeycomb while not interfering with its catalytic activity, such as for hydrogenation.

This application claims the benefit of priority under 35 U.S.C. §119 of U.S. Provisional Application Ser. No. 61/447257 filed on Feb. 28, 2011 the content of which is relied upon and incorporated herein by reference in its entirety.

### FIELD OF THE DISCLOSURE

This disclosure relates to a method of coating a substrate with a catalytically active material using a polymer latex.

### BACKGROUND

Known carbon coatings are prepared from a thermoset resin precursor, cross-linked and carbonized in an inert atmosphere at temperatures usually >800° C. Alternatively, carbon can be prepared as a fine powder, activated thermally to increase surface area, and chemically treated to create partially oxidized surfaces. The carbon powders prepared this way are then impregnated with metal salts to promote catalysis and selective adsorption.

### SUMMARY

We found that latex polymer binders are sufficient to bind a catalytically active platinum on activated carbon powder to a cordierite honeycomb while not interfering with its catalytic activity, such as for hydrogenation. The polymeric binder is not removed or decomposed after the coating procedure or under use treatment. In some embodiments, hydrogenation reactions, especially liquid-based for fine chemical synthesis, are done at temperatures below the polymer decomposition temperature. In addition, the binder can inhibit abrasion in liquid or solution-based reaction. Where catalysts are better prepared as powders for some applications, the present coating method separates the catalyst preparation from the coating process.

The method described herein coats catalyzed activated carbon, such as Pt/C, that retains catalytic activity after curing to a substrate. The method discloses dispersed polymers as binders, particularly, latexes that are suitable. A latex is generally defined as a stable dispersion of a polymer (usually colloidal) in an aqueous medium. The method also discloses the use of polymer T_{g} and latex pH as governing factors, affecting slurry rheology and binder (adhesion) quality.

Disclosed herein is a method of coating a substrate with a catalytically active material, the method comprising preparing a slurry comprising the catalytically active material and water; wherein the catalytically active material comprises activated carbon; preparing a binder comprising a polymer latex having a glass transition temperature of 10° C. to 30° C.; combining the slurry with the binder to form a mixture; and applying the mixture to the substrate to achieve a mixture loading of 20 to 30 weight percent.

Additional features and advantages will be set forth in the detailed description which follows, and in part will be readily apparent to those skilled in the art from the description or recognized by practicing the embodiments as described in the written description and claims hereof.

It is to be understood that both the foregoing general description and the following detailed description are merely exemplary, and are intended to provide an overview or framework to understand the nature and character of the claims.

### BRIEF DESCRIPTION OF THE DRAWINGS

FIG. 1 shows the conversion of NO to NH₃ according to one embodiment.

FIG. 2 shows the conversion of NO to NH₃ according to another embodiment.

### DETAILED DESCRIPTION

Disclosed herein is a method of coating a substrate with a catalytically active material, the method comprising preparing a slurry comprising the catalytically active material and water; wherein the catalytically active material comprises activated carbon; preparing a binder comprising a polymer latex having a glass transition temperature of 10° C. to 30° C.; combining the slurry with the binder to form a mixture; and applying the mixture to the substrate to achieve a mixture loading of 20 to 30 weight percent.

Exemplary substrates comprise glass, ceramic, glass-ceramic, polymer, or metal, including combinations thereof. Some example substrate materials include cordierite, mullite, clay, magnesia, metal oxides, talc, zircon, zirconia, zirconates, zirconia-spinel, magnesium alumino-silicates, spinel, zeolite, alumina, silica, silicates, borides, alumina-titanate, alumino-silicates, e.g., porcelains, lithium aluminosilicates, alumina silica, feldspar, titania, fused silica, nitrides (e.g. silicon nitride), borides, carbodes (e.g. silicon carbide), silicon nitride, metal carbonates, metal phosphates, wherein the metal can be, for example, Ca, Mg, Al, B, Fe, Ti, Zn, or combinations of these.

In embodiments, the substrate is honeycomb shaped, comprising an inlet end, an outlet end, and a multiplicity of cell extending from the inlet to the outlet end, the cells being defined by intersecting walls.

In some embodiments, the catalytically active material is activated carbon. The activated carbon may be thermally or chemically activated. Some embodiments disclosed herein comprise activated carbon comprising pore sizes from 0.001 microns to 100 microns. In some embodiments, at least 50%, at least 60%, at least 70%, or at least 80% of the pores in the activated carbon have diameters within the range of 0.01 microns to 1.0 microns. In some embodiments, at least 10%, at least 15%, or at least 20% of the pores in the activated carbon have diameters within the range of 5.0 microns to 50 microns. In some embodiments, the activated carbon comprises micropores, mesopores, and macropores. As defined herein, micropores have a pore diameter of 2 nanometers or less, mesopores have pore diameters ranging from 2 to 50 nanometers, and macropores have a pore diameter greater than 50 nanometers. Exemplary activated carbons include those disclosed in U.S. Pat. Nos. 6,024,899 and 6,248,691, the contents of both being incorporated by reference herein.

In some embodiments, the activated carbon has a metal catalyst dispersed thereon, for example, platinum on activated carbon (Pt/C). Other exemplary catalysts include gold, silver, rhodium, iron, transition metals, transition metal oxides, salts, and combinations thereof. In some embodiments, the isoelectric point (iep) of the catalytically active material is from about pH 5 to about pH 11, for example, the iep of activated carbon is about pH 11. The iep of platinum on activated carbon is about pH 5 to about pH 6.

In some embodiments, a slurry is prepared by mixing a catalytically active material with water to yield a solids content of from 20 to 90 weight percent, 20 to 80 weight percent, 20 to 70 weight percent, 20 to 60 weight percent, 20 to 50 weight percent, 20 to 40 weight percent, 20 to 30 weight percent, 30 to 80 weight percent, 30 to 70 weight percent, 30 to 60 weight percent, 30 to 50 weight percent, 30 to 40 weight percent, 40 to 90 weight percent, 40 to 80 weight percent, 40 to 70 weight percent, 40 to 60 weight percent, 40 to 50 weight percent, 50 to 90 weight percent, 50 to 80 weight percent, 50 to 70 weight percent, 50 to 60 weight percent, 60 to 90 weight percent, 60 to 80 weight percent, 60 to 70 weight percent, 70 to 90 weight percent, 70 to 80 weight percent, or 80 to 90 weight percent. Optionally, dispersants, for example Darvan® C, and/or surfactants, such as Tween® 20, may be added to the slurry. The amount of dispersants added to the slurry is typically between 0.2 and 4 weight percent. In some embodiments, the slurry is ball-milled with milling media for a period of minutes to hours to de-agglomerate particles and promote dispersion.

In some embodiments, a binder comprising a polymer latex, the polymer having a glass transition temperature (T_{g}) of from 10° C. to 30° C., is prepared. In some embodiments, the T_{g} of the polymer is 10 ° C., 15° C., 16° C., 17° C., 18° C., 19° C., 20° C., 21° C., 22° C., 23° C., 24° C., 25° C., or 30° C. Exemplary polymer latexes may be natural or synthetic, including acrylamide, polyvinyl alcohol, acrylate, styrene, and co-polymers, such as, acrylic-styrene latexes. In some embodiments, the polymer latex is an acrylic latex.

In some embodiments, the polymer latex comprises 20 to 60 weight percent solids, 20 to 50 weight percent solids, 20 to 40 weight percent solids, 20 to 30 weight percent solids, 30 to 60 weight percent solids, 30 to 50 weight percent solids, 30 to 40 weight percent solids, 40 to 60 weight percent solids, 40 to 50 weight percent solids, or 50 to 60 weight percent solids. The amount of latex is chosen to yield an equivalent of about 2 to about 20 weight percent polymer in the mixture after drying and curing.

In some embodiments, the pH of the binder is from about pH 2 to about pH 4, for example, about 2.5, 3, or 3.5.

In the method disclosed herein, the slurry is combined with the binder to form a mixture before coating the substrate. The mixture may be used immediately after combining, or may be stirred for 1 to 24 hours to promote dispersion. The pH of the binder and T_{g} of the polymer should be compatible with the iep of the dispersed catalytically active material. The pH of the binder and the T_{g} of the polymer can impact the rheology of the mixture. For example, if the polymer is too soft (i.e., well below use temperature) the catalytically active material can cause slurry flocculation. As the examples in Table 1 show, flocculation was observed with DURAMAX™ B1000 latex (Dow), which has a T_{g} of −26° C. When a latex with a higher T_{g} was used, such as DURAMAX™ B1022 (Tg=39), the mixture thickens but does not flocculate. While the DURAMAX™ B1000 and DURAMAX™ B1022 binders have a basic pH, the iep of the Pt/C is acidic.

A Pt/C coating with the DURAMAX™ B1022 binder did not provide optimal adhesion; the coating could be abraded as a powder. When a binder with a pH compatible with the catalytically active material and low enough T_{g} (soft for good adhesion) was used, as with the DURAMAX™ HA12 binder, coating quality was good with good abrasion resistance.

TABLE 1

| Latex Binder | Wt % Solids | T_{g}, ° C. | pH | Effect |
|---|---|---|---|---|
| DURAMAX ™ | 55 | −26 | 9.0-9.8 | Flocculation/poor |
| B1000 | | | | adhesion |
| DURAMAX ™ | 45 | 39 | 7.0-8.0 | No flocculation, |
| B1022 | | | | thickening/modest |
| | | | | adhesion |
| DURAMAX ™ | 45 | 19 | 2.1-4.0 | No flocculation, thin |
| HA12 | | | | slurry/good |
| | | | | adhesion |

In some embodiments, the mixture is applied to the substrate to achieve a mixture loading of 20 to 30 weight percent. The substrate can be coated with a mixture, for example, by dipping the substrate in the mixture or spraying the mixture on the substrate. The mixture may also be applied by coating under vacuum. In some embodiments, the coated substrate is dried and cured after coating.

The eventual quantity of catalytically active material and polymer formed on the substrate is dependent on the amount of mixture that is retained by the substrate. The amount of mixture retained by the substrate may be increased, for example, by increasing the contact time of the substrate with the mixture. Contacting the substrate with the mixture more than once and allowing the substrate to dry between contacting steps may also increase the amount of mixture retained by the substrate. In addition, the amount of mixture retained by the substrate can be controlled by simply modifying the overall porosity of the substrate (e.g., increasing porosity will increase the amount of mixture retained by the substrate).

In some embodiments, the mixture is present as a layer. For example, the substrate is coated with a layer that comprises the mixture. The term “layer” as used herein means that the mixture is disposed on an exposed surface of the substrate. The layer may coat all or a portion of the surface of the substrate, and may impregnate the substrate to some extent, for example in embodiments that comprise a substrate with a porous surface. For instance, the layer may coat the inner pore and/or wall surfaces of a substrate and/or other outer surfaces of the substrate. In some embodiments, the mixture is in the form of an uninterrupted and continuous layer over all or a portion of the surface of the substrate. In other embodiments, the layer includes cracks, pinholes, or other discontinuities. In some embodiments, portions of the exposed surfaces of the substrate remain uncoated.

The article made by the disclosed method may be useful for appropriate gas, liquid, or solution based reactions. In one embodiment, the gas phase reaction is a hydrogenation reaction. Other exemplary reactions include non oxidative reactions and steam reforming reactions.

Various embodiments will be further clarified by the following examples.

### EXAMPLES

Cordierite honeycombs with 200/12 geometry were dipped into the mixture. The channels were cleared with compressed air. The coated honeycomb was dried at 85° C. for 20 minutes. The process was repeated to the desired coat loading of ˜20-30 wt %.

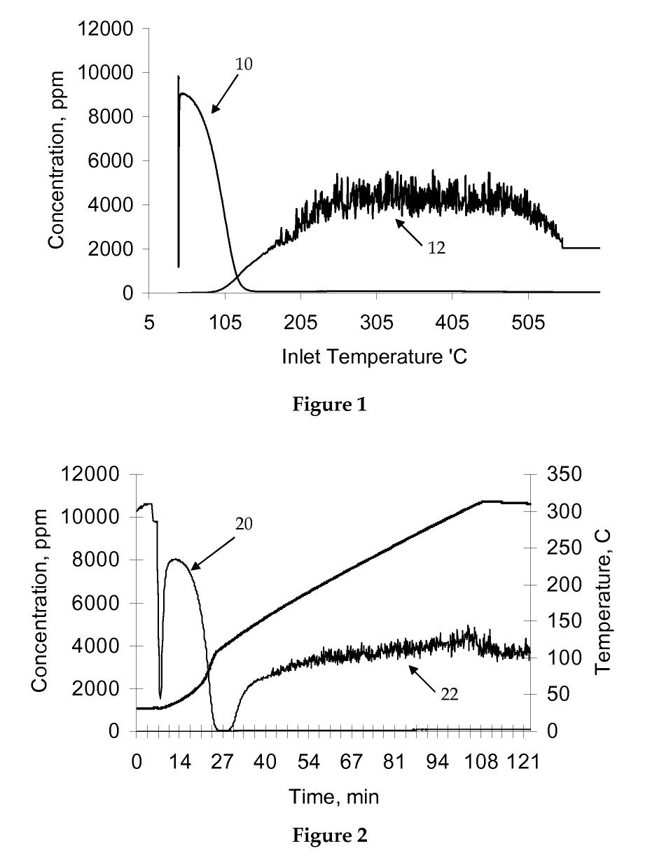

Four honeycombs were tested in tandem in a bench-scale reactor for the gas-phase hydrogenation of NO. The catalyzed honeycombs were degassed at 100° C. in flowing N₂, cooled to room temperature and exposed to a equimolar mixture of NO and H₂ in N₂. The temperature was ramped. Several reaction testing experiments were done. The results shown in FIG. 1, show rapid 100% conversion of NO 10 to NH₃ 12 by 125° C. exposure above 300° C. can cause binder degradation.

FIG. 2 shows the catalyzed honeycomb obtained 50% conversion of NO 20 to NH₃ 22 at ˜95° C. and 100% conversion by ˜140° C. After exposure to 225° C., the coating retains good adhesion and loses little abrasion resistance. For many gas and mixed phase hydrogenation reactions for fine chemical synthesis that occur below 300° C., this technique provides a good form factor for the catalyst with high geometric surface area, independently controlled hydraulic diameter and wall thickness, with high catalyst exposure that can yield an effectiveness factor of near unity.

It should be understood that while the invention has been described in detail with respect to certain illustrative embodiments thereof, it should not be considered limited to such, as numerous modifications are possible without departing from the broad spirit and scope of the invention as defined in the appended claims.

Unless otherwise indicated, all numbers used on the specification and claims are to be understood as being modified in all instances by the term “about”, whether or not so stated. It should also be understood that the precise numerical values used on the specification and claims form additional embodiments of the invention.

What is claimed is:

1. A method of applying a catalytically active material to a substrate, the method comprising:
preparing a slurry comprising the catalytically active material and water;
wherein the catalytically active material comprises activated carbon;
preparing a binder comprising a polymer latex having a glass transition temperature of 10° C. to 30° C.;
combining the slurry with the binder to form a mixture; and
applying the mixture to the substrate to achieve a mixture loading of 20 to 30 weight percent on the substrate.

2. The method of claim 1, wherein the substrate comprises glass, glass-ceramic, ceramic, or metal, and combinations thereof.

3. The method of claim 1, wherein the substrate comprises cordierite.

4. The method of claim 1, wherein the substrate is honeycomb shaped.

5. The method of claim 1, wherein the slurry comprises 20 to 90 weight percent solids.

6. The method of claim 1, wherein the slurry comprises a dispersant and/or a surfactant.

7. The method of claim 1, wherein the catalytically active material comprises platinum on activated carbon.

8. The method of claim 1, wherein the isoelectric point of the catalytically active material is from pH 5 to pH 11.

9. The method of claim 1, wherein the isoelectric point of the catalytically active material is from pH 5 to pH 6.

10. The method of claim 1, wherein the polymer latex is an acrylic latex.

11. The method of claim 1, wherein the polymer latex comprises 20 to 60 weight percent solids.

12. The method of claim 1, wherein the glass transition temperature of the polymer is from 2° C. to 4° C.

13. The method of claim 1, wherein the pH of the binder is from about pH 2 to pH 4.

14. The method of claim 1, wherein the binder comprises a natural or synthetic polymer latex.
